(19) United States
(12) Patent Application Publication
(10) Pub. No.: US 2016/0062876 A1
(43) Pub. Date: Mar. 3, 2016

(54) AUTOMATED SOFTWARE CHANGE MONITORING AND REGRESSION ANALYSIS

(71) Applicant: Ajit Kumar Narayanan, Whitefield (IN)

(72) Inventor: Ajit Kumar Narayanan, Whitefield (IN)

(21) Appl. No.: 14/476,226

(22) Filed: Sep. 3, 2014

(51) Int. Cl. G06F 11/36; G06F 9/44; G06N 5/02

(52) U.S. Cl. CPC G06F 11/3684; G06N 5/022; G06F 8/71

(57) ABSTRACT

The present disclosure describes methods, systems, and computer program products for providing automatic regression analysis of software source code. One computer-implemented method includes selecting particular source code of a software produce from a source code repository, preparing the selected source code to extract information while executing, performing a series of actions on the prepared selected source code resulting in logged data associated with the performed actions, submitting the logged data to an automatic regression analyzer application, determining changes made to the particular source code, and determining software tests needed to be executed to properly test the changed particular source code and other affected source code.

### BACKGROUND

A well-maintained software product typically has well documented source code, up-to-date design documents and up-to-date technical documentation (e.g., design, specification, features, usage, etc.). In a software development lifecycle, once a software product has reached a certain maturity or in legacy software systems, fixing a software coding bug in the software produce can become a tedious task. Between the discovery of the software coding bug and the development of the software, many updates may have occurred to the software product source code over many years of usage, there may have been turnover of multiple software developers/technical experts, and/or manual/automated tests (“software tests”) may have been missed. As a result, the software product source code becomes out-of-sync with the technical documentation. Fixing the software coding bug typically falls on someone (e.g., a software developer) with little to no connection to the originally designed software.

Once the software coding bug has been fixed, a software developer has no automated means to figure out what manual/automated tests, other source code, etc. are affected by the particular source code modified to fix the software coding bug. Due to the typical time and expense of re-executing all known software tests, analyzing what other source code is affected by the fix, etc., organizations often perform incomplete testing (e.g., test sampling, general feature testing, etc.) to just verify the fix for the software coding bug. This incomplete testing can result in the introduction new software coding bugs (“regressions”). The introduction of regressions can result in monetary loss, expensive/time-consuming rework, customer confusion and dissatisfaction, a poor user experience, and/or rejection of software in favor of competing products.

### SUMMARY

The present disclosure relates to computer-implemented methods, computer-readable media, and computer systems for providing automatic regression analysis of software source code. One computer-implemented method includes selecting particular source code of a software produce from a source code repository, preparing the selected source code to extract information while executing, performing a series of actions on the prepared selected source code resulting in logged data associated with the performed actions, submitting the logged data to an automatic regression analyzer application, determining changes made to the particular source code, and determining software tests needed to be executed to properly test the changed particular source code and other affected source code.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein preparing the selected source code includes instrumenting the selected source code.

A second aspect, combinable with any of the previous aspects, wherein preparing the selected source code includes using byte code injection or aspect-oriented programming methods during building of the selected source code into executable form.

A third aspect, combinable with any of the previous aspects, comprising writing the logged data to a knowledge base.

A fourth aspect, combinable with any of the previous aspects, comprising using rules with the knowledge base to provide analytical intelligence with respect to the written logged data.

A fifth aspect, combinable with any of the previous aspects, comprising monitoring the particular source code in the source code repository using a watch dog agent.

A sixth aspect, combinable with any of the previous aspects, comprising generating a list of the determined software tests.

The subject matter described in this specification can be implemented in particular implementations so as to realize one or more of the following advantages. First, an automated software system can monitor any changes to software code so that all changes are determined. Second, the determined changes can be analyzed to further determine the impact to other software code. Third, the determined changes can be analyzed to further determine an impact to both manual and automated software tests and/or to inform developers/testers which software tests need to be executed to exercise the determined changes to the software code. This helps to avoid introducing regression errors into software and to reduce the time and expense of adequately testing modified software by allowing unnecessary software tests to be skipped. Fourth, analytics can be designed to determine which parts of software code are not exercised/unreachable (“dead code”) and can be removed to streamline the software code. Fifth, analytics can be designed to determine what parts of software need a re-design or re-write based on a frequency, severity, etc. of fixes. Sixth, the implementation of the described subject matter can increase developer confidence in fixing software bugs and that software bugs have been reduced or eliminated. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system (EDCS) for providing automatic regression analysis of software source code according to an implementation.

FIG. 2 is a block diagram illustrating an example client/server architecture of the EDCS for providing automatic regression analysis of software source code according to an implementation.

FIG. 3 is a flow chart illustrating a method for providing automatic regression analysis of software source code according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

This disclosure describes computer-implemented methods, computer-program products, and systems for providing automatic regression analysis of software source code.

A well-maintained software product typically has well documented source code, up-to-date design documents and up-to-date technical documentation (e.g., design, specification, features, usage, etc.). In a software development lifecycle, once a software product has reached a certain maturity or in legacy software systems, fixing a software coding bug in the software produce can become a tedious task. Between the discovery of the software coding bug and the development of the software, many updates may have occurred to the software product source code over many years of usage, there may have been turnover of multiple software developers/technical experts, and/or manual/automated tests (“software tests”) may have been missed. As a result, the software product source code becomes out-of-sync with the technical documentation. Fixing the software coding bug typically falls on someone (e.g., a software developer) with little to no connection to the originally designed software.

Once the software coding bug has been fixed, a software developer has no automated means to figure out what manual/automated tests, other source code, etc. are affected by the particular source code modified to fix the software coding bug. Due to the typical time and expense of re-executing all known software tests, analyzing what other source code is affected by the fix, etc., organizations often perform incomplete testing (e.g., test sampling, general feature testing, etc.) to just verify the fix for the software coding bug. This incomplete testing can result in the introduction new software coding bugs (“regressions”). The introduction of regressions can result in monetary loss, expensive/time-consuming rework, customer confusion and dissatisfaction, a poor user experience, and/or rejection of software in favor of competing products.

Actually running code is the most accurate method of testing code (e.g., to ensure accurate results, complete code coverage, etc.). Code can be analyzed to provide design, specification, and test documentations. What is needed is a way to use information embedded in software product source code to allow an automatic regression analyzer to analyze the impact of changes to code and to recommend appropriate software tests to perform to test all affected areas of the software product's code.

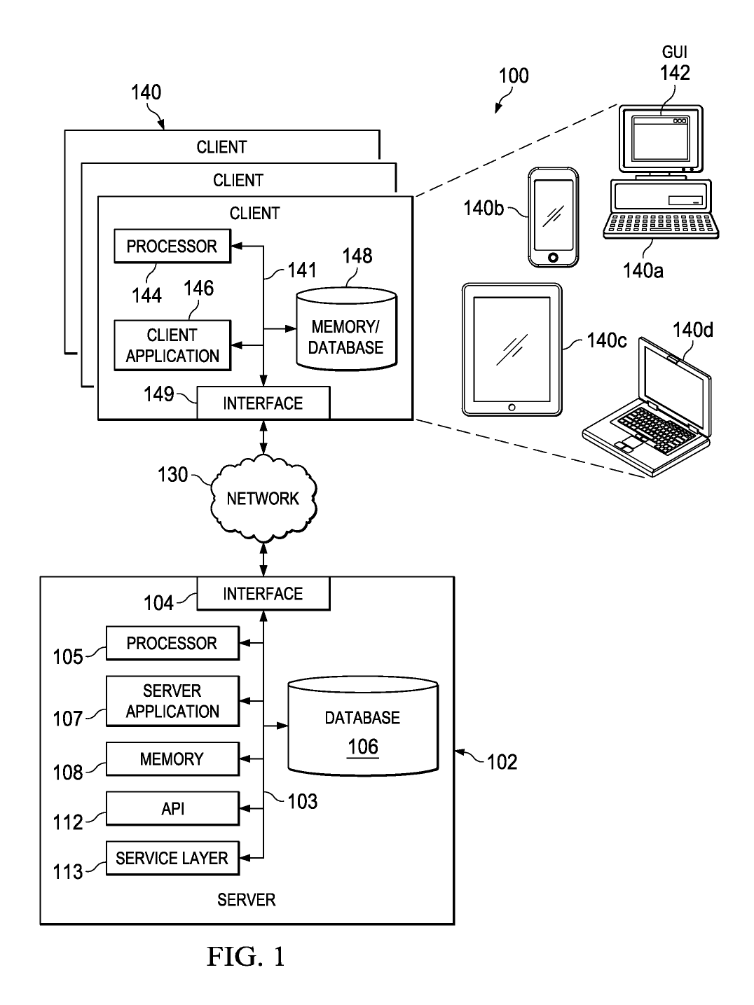

FIG. 1 is a block diagram illustrating an example distributed computing system (EDCS) 100 for providing automatic regression analysis of software source code according to an implementation. The illustrated EDCS 100 includes or is communicably coupled with a server 102 and a client 140 that communicate across a network 130. In some implementations, one or more components of the EDCS 100 may be configured to operate within a cloud-computing-based environment. As will be apparent to those of ordinary skill in the art, other implementations of the EDCS 100 are possible. The illustrated example in FIG. 1 should be considered to limit other implementations in any way.

At a high level, the server 102 is an electronic computing device operable to receive, transmit, process, store, or manage data and information associated with the EDCS 100. In general, the server 102 can provides functionality appropriate to a server, including database functionality and receiving/serving content and/or functionality from/to a client permitting, for example, providing automatic regression analysis of software source code as described herein. According to some implementations, the server 102 may also include or be communicably coupled with an e-mail server, a web server, a caching server, a streaming data server, a business intelligence (BI) server, and/or other server. In some implementations, server 102 can also provide functionality normally associated with a client, for example some or all of the functional described below with respect to client 140.

The server 102 is responsible for receiving, among other things, data, requests, and/or content from one or more client applications 146 associated with the client 140 of the EDCS 100. The server 102 can also respond to received requests, for example requested processed by a server application 107 and/or database 106. In addition to requests received from the client 140, requests may also be sent to the server 102 from internal users, external or third-parties, other automated applications, as well as any other appropriate entities, individuals, systems, or computers. In some implementations, various requests can be sent directly to server 102 from a user accessing server 102 directly (e.g., from a server command console or by other appropriate access method).

Each of the components of the server 102 can communicate using a system bus 103. In some implementations, any and/or all the components of the server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure. For example, the API 112 could be integrated into the database 106, the server application 107, and/or wholly or partially in other components of server 102 (whether or not illustrated).

The server 102 includes an interface 104. Although illustrated as a single interface 104 in FIG. 1, two or more interfaces 104 may be used according to particular needs, desires, or particular implementations of the EDCS 100. The interface 104 is used by the server 102 for communicating with other systems in a distributed environment—including within the EDCS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The server 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the server 102. Specifically, the processor 105 executes the functionality required for providing automatic regression analysis of software source code.

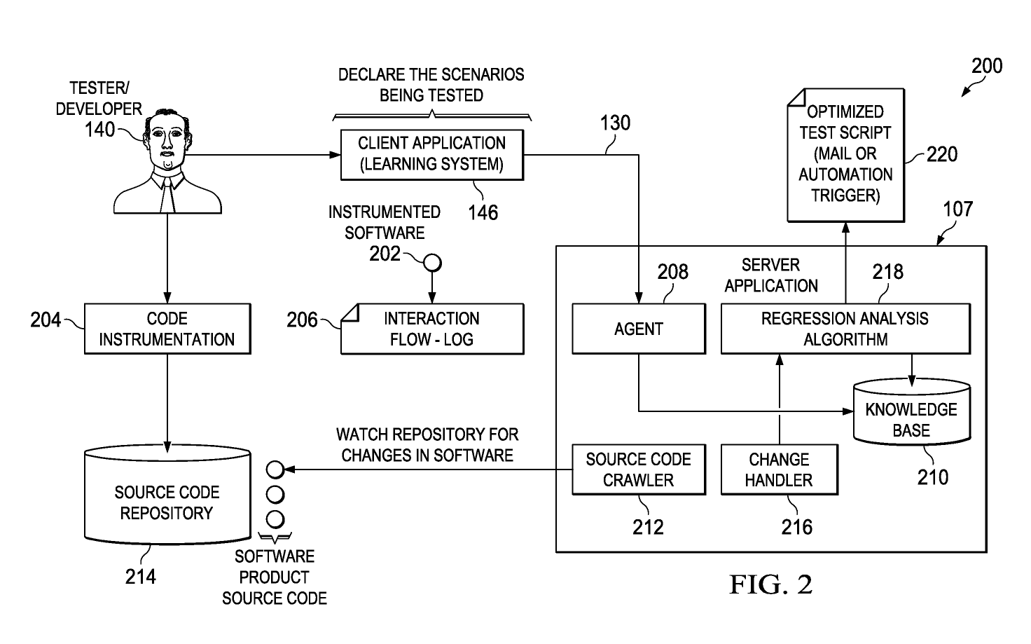

The server 102 also includes a database 106 that holds data for the server 102, client 140, and/or other components of the EDCS 100. Although illustrated as a single database 106 in FIG. 1, two or more databases may be used according to particular needs, desires, or particular implementations of the EDCS 100. While database 106 is illustrated as an integral component of the server 102, in alternative implementations, database 106 can, in whole or in part, be external to the server 102 and/or the EDCS 100. In some implementations, database 106 can be configured to store one or more instances of a source code repository (not illustrated—see FIG. 2), knowledge base (not illustrated—see FIG. 2), and/or other appropriate data (e.g., user profiles, objects and content, client data, etc.—whether or not illustrated).

The server application 107 is any type of application/algorithmic software engine capable of providing, among other things, any appropriate function consistent with this disclosure for automatic regression analysis of software source code. For example, the server application 107 can provide and/or manage an agent, change handler, source code crawler, regression analysis algorithm, and/or knowledge base (see FIG. 2).

The server 102 can also provide functions particular to the server 102 and/or one or more clients 140 (e.g., receiving from, processing, and/or transmitting data to a client 140). In some implementations, the server application 107 can provide and/or modify content provided by and/or made available to other components of the EDCS 100. In other words, the server application 107 can act in conjunction with one or more other components of the server 102 and/or EDCS 100 in responding to a request for content received from the client 140.

Although illustrated as a single server application 107, the server application 107 may be implemented as multiple server applications 107. In addition, although illustrated as integral to the server 102, in alternative implementations, the server application 107 can be external to the server 102 and/or the EDCS 100 (e.g., wholly or partially executing on the client 140, other server 102 (not illustrated), etc.). Once a particular server application 107 is launched, the particular server application 107 can be used, for example by an application or other component of the EDCS 100 to interactively process received requests (e.g., from client 140). In some implementations, the server application 107 may be a network-based, web-based, and/or other suitable application consistent with this disclosure.

In some implementations, a particular server application 107 may operate in response to and in connection with at least one request received from other server applications 107, other components (e.g., software and/or hardware modules) associated with another server 102, and/or other components of the EDCS 100. In some implementations, the server application 107 can be accessed and executed in a cloud-based computing environment using the network 130. In some implementations, a portion of a particular server application 107 may be a web service associated with the server application 107 that is remotely called, while another portion of the server application 107 may be an interface object or agent bundled for processing by any suitable component of the EDCS 100. Moreover, any or all of a particular server application 107 may be a child or sub-module of another software module or application (not illustrated) without departing from the scope of this disclosure. Still further, portions of the particular server application 107 may be executed or accessed by a user working directly at the server 102, as well as remotely at a corresponding client 140. In some implementations, the server 102 or any suitable component of server 102 or the EDCS 100 can execute the server application 107.

The memory 108 typically stores objects and/or data associated with the purposes of the server 102 but may also be used in conjunction with the database 106 to store, transfer, manipulate, etc. objects and/or data. The memory 108 can also consistent with other memories within the EDCS 100 and be used to store data similar to that stored in the other memories of the EDCS 100 for purposes such as backup, caching, and/or other purposes.

The client 140 may be any computing device operable to connect to and/or communicate with at least the server 102. In general, the client 140 comprises an electronic computing device operable to receive, transmit, process, and store any appropriate data associated with the EDCS 100, for example, the server application 107. More particularly, among other things, the client 140 can collect content from the client 140 and upload the collected content to the server 102 for integration/processing into/by the server application 107 and/or other component of server 102. The client typically includes a processor 144, a client application 146, a memory/database 148, and/or an interface 149 interfacing over a system bus 141.

In some implementations, the client application 146 can use parameters, metadata, and other information received at launch to access a particular set of data from the server 102 and/or other components of the EDCS 100. Once a particular client application 146 is launched, a user may interactively process a task, event, or other information associated with the server 102 and/or other components of the EDCS 100.

The client application 146 is any type of application/algorithmic software engine that allows the client 140 to, among other things, navigate to/from, request, view, create, edit, delete, administer, and/or manipulate content associated with the server 102 and/or the client 140. For example, the client application 146 can present GUI displays and associated data (e.g., contextual data from one or more other clients 140) to a user that is generated/transmitted by the server 102 (e.g., the server application 107, and/or database 106). In some implementations, the client application 146 can act as a learning system (see FIG. 2) to processes, instrument, teach, and/or perform other functions related to software source code and to transmit various data associated with these functions to the server 102.

In some implementations, the client application 146 can also be used perform administrative functions related to the client 140 (or any component of client 140), the server 102 (or any component of the server 102—for example, application 107, database 106, API 112, etc.). For example, the server application 107 can generate and/or transmit administrative pages to the client application 146 based on a particular user login, request, etc. to allow configuration of the server application 107 or database 106 on the server 102.

Further, although illustrated as a single client application 146, the client application 146 may be implemented as multiple client applications in the client 140. For example, there may be a native client application and a web-based (e.g., HTML) client application depending upon the particular needs of the client 140 and/or the EDCS 100.

The interface 149 is used by the client 140 for communicating with other computing systems in a distributed computing system environment, including within the EDCS 100, using network 130. For example, the client 140 uses the interface to communicate with a server 102 as well as other systems (not illustrated) that can be communicably coupled to the network 130. The interface 149 may be consistent with the above-described interface 104 of the server 102. The processor 144 may be consistent with the above-described processor 105 of the server 102. Specifically, the processor 144 executes instructions and manipulates data to perform the operations of the client 140, including the functionality required to send requests to the server 102 and to receive and process responses from the server 102 as well as to processes, instrument, teach, and/or perform other functions related to software source code and to transmit various data associated with these functions to the server 102.

The memory/database 148 typically stores objects and/or data associated with the purposes of the client 140 but may also be consistent with the above-described database 106 and/or memory 108 of the server 102 or other memories within the EDCS 100 and be used to store data similar to that stored in the other memories of the EDCS 100 for purposes such as backup, caching, and the like. Although illustrated as a combined memory/database, in some implementations, the memory and database can be separated (e.g., as in the server 102).

Further, the illustrated client 140 includes a GUI 142 that interfaces with at least a portion of the EDCS 100 for any suitable purpose. For example, the GUI 142 (illustrated as associated with client 140a) may be used to view data associated with the client 140, the server 102, or any other component of the EDCS 100. In particular, in some implementations, the client application 146 may render GUI interfaces received from the server application 107 and/or data retrieved from any element of the EDCS 100.

There may be any number of clients 140 associated with, or external to, the EDCS 100. For example, while the illustrated EDCS 100 includes one client 140 communicably coupled to the server 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

FIG. 2 is a block diagram 200 illustrating an example client/server architecture of the EDCS 100 for providing automatic regression analysis of software source code according to an implementation. In the example illustration, client 140 (“Tester/Developer”) uses application 146 (as the above-described learning system) connected to server application 107 (as part of server 102) using network 130. As described above, the learning system 146 can provide functionality including processing, instrumenting, teaching, and/or performing other functions related to software source code and transmitting various data associated with these functions to the server 102.

Preparation

A tester/developer 140 can use the learning system 146 to select particular software source code (“source code”) in a source code repository 214 and prepare the source code to extract information from the source code (e.g., source code structure, data types, method names, external access, etc.). In some implementations, preparing the source code means that the tester/developer 140 can rebuild the source code using byte code injection and/or aspect-oriented programming methods (or an equivalent as understood by one of ordinary skill in the art) to instrument the source code (e.g., instrumented software 202/code instrumentation 204). In this manner, the source code can be instrumented in a way to write to a log all the method interactions (e.g., to an interaction flow log 206) when actions are performed by the tester/developer using the re-built source code. In some implementations, information about the actual test data used can be captured if it is desired to determine, for example, memory leaks, unusual peaks in response times, etc. during the running of a test.

As an example, during a build of an example JAVA application source code into machine code (byte code), the byte code is altered to inject additional processor instructions that the original software does not have. In this case, before the byte code instructions for a method begins, the instrumentation will inject code to write to a log file, that “that method” is being called and as a part of “which scenario.” The scenario information from other sections of the instrumentation which tracks which scenario is being executed is also written to a log file. In some implementations, the source code repository 214 can be wholly or partially associated with the database 106. In other implementations, the source code repository can be separate from the database 106.

Teaching

The tester/developer 140 can also use the learning system 146 to teach the automatic regression analyzer application information about software tests and/or scenarios for the instrumented source code 202. For example, the tester/developer 140 performs a series of actions/software tests on the instrumented source code 202 and the result data is logged (e.g., in the interaction flow log 206—that a method is called, which scenario the call is part of, available memory, consumed memory, test data used, etc.).

Once the desired actions are completed, the tester/developer 140 declares the software product software test case and/or scenario executed and submits the logged data related to the performance of the actions on the instrumented source code 202 to an agent 208 associated with server 102. For example, a software tester can use an appropriate tool to:
1. Open tool and create a new “Teaching session.”
2. Provide the name of the product being tested.
3. If the product is already known to the tool, the tool can list details of the product such as source repository location, assigned testers etc. This information is picked from the central knowledge repository.
4. If the product was known previously, then the tool can also list the captured test cases.
5. Choose to re-teach an existing test case or add a new test case.
6. Provide the name of the test case and click start.
7. Opens the product (which has been instrumented) and start a test run.

The agent 208 is any type of application/algorithmic software engine that can, among other things, classify software (both the software product and source code) and test case and/or scenario, and log the method interaction data (e.g., the interaction flow log 206 in the knowledge base 210) for a particular test case and/or scenario. In typical implementations, the knowledge base stores, for example, a name of the product and details of the product (e.g., owner, tester names and email IDs, product description, list of known test cases, when and by who the test cases were recorded, if the test cases are active, where sources for the product are stored and what type of repository is used, details about what test case classes and methods were invoked, rules for analysis, etc.).

Allowing the agent 208 to capture this data for known flows in the source code allows for a complete knowledge base 210. In some implementations, the agent 208 or other component of the illustrated server application (acting as an automatic regression analyzer application) 107 can additionally process (e.g., post-process) the data received by the agent 208 prior to storage in the knowledge base 210.

The knowledge base 210 (e.g., a conventional and/or in-memory database, data structure, or other knowledge base) is used to identify test cases that need to be re-run if the instrumented source code 202 is modified. For example, when the agent 208 pushes method interaction data to the knowledge base 210, this data can be processed to determine, among other things, what actions executed what methods, what methods exercise what actions, etc. While this is only a simple example, one of ordinary skill should be able to see that, in some implementations, the knowledge base can act as or part of a database (e.g., database 106) and be queried for data to determine multiple aspects related to, among other things, source code methods, variables, modules, and tests/scenarios that execute each of these as well as other aspects of the instrumented source code 202.

The knowledge base 210 has the ability to be extended for deep analytics purposes. For example, a database already has information about memory usage, etc. Therefore, in an actual run of software tests, quality/testing can be informed if there are changes in patterns to memory usage from one test run to another. Additionally, there can be rules defined on top of the content in the knowledgebase 210 to provide analytical intelligence with respect to logged data (e.g., to define what constitutes “identification of a test subset”). For example, there could be particular rules defined (not illustrated) to actually determine if there has been control flow changes in code versions (and, for example, not just changes in comments, etc.). As an example, if a new null check was introduced, it is not necessary to rerun any tests although purely from the perspective of the knowledge base 210 it might seem that it would indicate that software tests need to be rerun. Intelligence to determine whether or not this is the case (or other scenarios) can reside in the knowledge base 210. In some implementations, the intelligence can be part of the regression analysis algorithm 218 and/or other component of the EDCS 100 working in conjunction with the knowledge base 210 (whether or not illustrated).

Although illustrated as associated with the server application 107, in some implementations, the knowledge base 210 can be partially or fully separate from the server application 107. For example, the knowledge base 210 can be integral to the server application 107. In another example, server application 107 can access a knowledge base that is part of database 106 (or other database/memory).

Monitoring

The automatic regression analyzer application 107 can be triggered (e.g., manually and/or automatically) to keep watch on the unaltered source code 202 present in the source code repository 214. For example, the tester/developer 140 can use the learning system 146 to start monitoring of source code in the source code repository 214. When modified source code is committed to the source code repository 214, the change in the source code can be detected automatically through monitoring.

In some implementations, the source code repository 214 can be monitored using a watch dog agent on the source code repository (not illustrated) and/or a source code crawler 212/change handler 216. In implementations with a watch dog agent, the watch dog agent can be any application/algorithmic software engine that can, for example, compare source code for changes, detect that changes have been made to existing source code (e.g., a previously generated baseline), and/or generate an alert, message, and/or other type of notification to that effect. In implementations with a source code crawler 212, the source code crawler 212 can be any application/algorithmic software engine that can, for example, “crawl” over a repository of source code to detect changes to existing source code (e.g., a previously generated baseline), and/or generate an alert, message, and/or other type of notification to that effect. In some implementations, the source code crawler can be manually triggered and/or executed in an automated manner (e.g., a timed basis or based on a notification). In some implementations, the watch dog agent can notify the source code crawler 212 that a change has occurred in the source code repository 214 and the source code crawler can analyze the identified changed code using a change handler 216 (e.g., any application/algorithmic software engine) to determine differences to an existing baseline of source code. It should be apparent to those of ordinary skill in the art that many different methods can be used to determine that source code has changed and to obtain the changes. These alternative methods are also considered to be within the scope of this application.

The automatic regression analyzer algorithm 218 receives/pulls source code change information from the change handler 216. Using the knowledge base 210, the automatic regression analyzer algorithm 218 automatically determines which software tests and/or scenarios (e.g., a generated optimized test script 220) need to be executed to exercise the changed source code. The generated optimized test script 220 can be related to the software developer, software quality assurance test team, etc. In some implementations, the determined software tests and/or scenarios can be used to drive automated testing tools which can automatically regression test the updated software product.

In some implementations, the automatic regression analyzer algorithm 218 and/or the knowledge base 210 can contain or have access to a rule set (not illustrated) used by the automatic regression analyzer algorithm 218 to determine which software tests and/or scenarios (e.g., a generated optimized test script 220) need to be executed to exercise the changed source code. The rule set can also be used by the knowledge base 210 to determine what information is to be written to the knowledge base 210, in what format, security protocols (e.g., encryption), etc. The rule set can also be used for any purpose consistent with this disclosure.

In some implementations, once a change to source code has been made by a software developer (e.g., tester/developer 140), the software developer can manually identify/assert classes, methods, modules, etc. changed through the agent 208 and the automatic regression analyzer application 107 (e.g., using the knowledge base 210 and automatic regression analyzer algorithm 218) can identify which software tests and/or scenarios (e.g., a generated optimized test script 220) need to be executed to exercise the changed source code. The generated optimized test script 220 can be related to the software developer, software quality assurance test team, etc. In these implementations, the watch dog agent, source code crawler, and/or change handler 216 can be ignored and not executed or either can be executed to confirm the software developer's assertions.

If there are fundamental changes to the source code in the source code repository 214, the system would need to be “taught” again. In some implementations, this determination can be calculated by introduction of new methods during a COMMIT to the database. The watch dog agent can identify the changes due to the COMMIT and inform quality/testing personnel that there are too many changes to adequately test the software system using the known “valid” captured scenarios. The quality/testing individuals can then assess the impact of the changes with the developer and choose to re-teach the system one or more particular test cases.

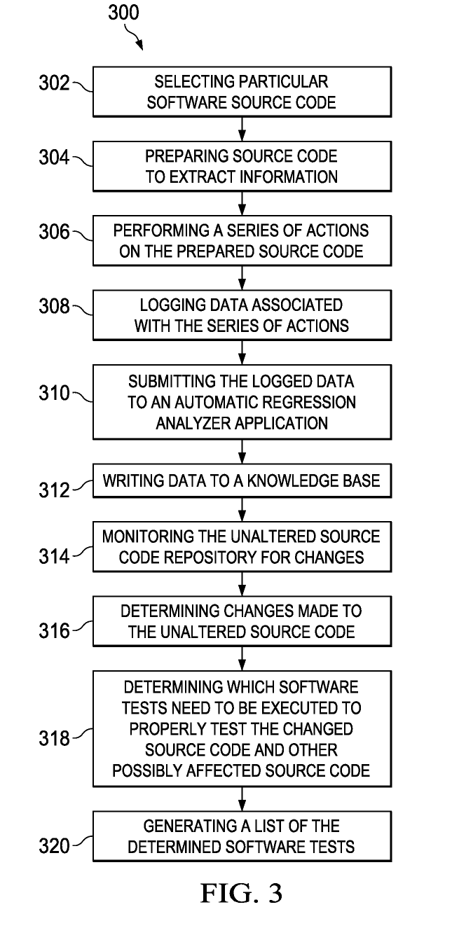

FIG. 3 is a flow chart illustrating a method 300 for providing automatic regression analysis of software source code according to an implementation. For clarity of presentation, the description that follows generally describes method 300 in the context of FIGS. 1-2. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, and/or in any order.

At 302, a user (e.g., a tester/developer) selects particular source code of a software product. From 302, method 300 proceeds to 304.

At 304, the user prepares the selected source code to extract information while executing. For example, the user can instrument the source code to log information when the source code is executed using, for example, byte code injection and/or aspect-oriented programming methods (or an equivalent as understood by one of ordinary skill in the art) during building of the source code into executable form. From 304, method 300 proceeds to 306.

At 306, the user performs a series of actions on the prepared source code (e.g., by executing the built prepared source code). From 306, method 300 proceeds to 308.

At 308, the series of actions generate log data which is logged. From 308, method 300 proceeds to 310.

At 310, the logged data is submitted to an automatic regression analyzer application. From 310, method 300 proceeds to 312.

At 312, the logged data is written to a knowledge base. From 312, method 300 proceeds to 314.

At 314, the source code repository is monitored for changes to the unaltered source code. From 314, method 300 proceeds to 316.

At 316, changes to the unaltered source code are detected and identified. From 316, method 300 proceeds to 318.

At 319, which software tests need to be executed are determined to properly test the changed source code and other possibly affected code. From 318, method 300 proceeds to 320.

At 320, a list of the software tests is generated and transmitted to appropriate quality/testing personnel, tools, etc. for testing. After 320, method 300 stops.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus,” “computer,” or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
selecting particular source code of a software produce from a source code repository;
preparing the selected source code to extract information while executing;
performing a series of actions on the prepared selected source code resulting in logged data associated with the performed actions, the actions performed as part of a teaching function to learn information about software tests or scenarios for the prepared selected source code to enhance a knowledge base used to identify software tests that need to be re-run if the prepared selected source code is modified;
submitting the logged data to an automatic regression analyzer application;
determining changes made to the particular source code; and
determining software tests needed to be executed to properly test the changed particular source code and other affected source code.

2. The method of claim 1, wherein preparing the selected source code includes instrumenting the selected source code.

3. The method of claim 1, wherein preparing the selected source code includes using byte code injection or aspect-oriented programming methods during building of the selected source code into executable form.

4. The method of claim 1, comprising writing the logged data to the knowledge base.

5. The method of claim 4, comprising using rules with the knowledge base to provide analytical intelligence with respect to the written logged data.

6. The method of claim 1, comprising monitoring the particular source code in the source code repository using a watch dog agent.

7. The method of claim 1, comprising generating a list of the determined software tests.

8. A non-transitory, computer-readable medium storing computer-readable instructions executable by a computer and configured to:
select particular source code of a software produce from a source code repository;
prepare the selected source code to extract information while executing;
perform a series of actions on the prepared selected source code resulting in logged data associated with the performed actions, the actions performed as part of a teaching function to learn information about software tests or scenarios for the prepared selected source code to enhance a knowledge base used to identify software tests that need to be re-run if the prepared selected source code is modified;
submit the logged data to an automatic regression analyzer application;
determine changes made to the particular source code; and
determine software tests needed to be executed to properly test the changed particular source code and other affected source code.

9. The medium of claim 8, wherein preparing the selected source code includes instrumenting the selected source code.

10. The medium of claim 8, wherein preparing the selected source code includes using byte code injection or aspect-oriented programming methods during building of the selected source code into executable form.

11. The medium of claim 8, comprising instructions to write the logged data to the knowledge base.

12. The medium of claim 11, comprising instructions to use rules with the knowledge base to provide analytical intelligence with respect to the written logged data.

13. The medium of claim 8, comprising instructions to monitor the particular source code in the source code repository using a watch dog agent.

14. The medium of claim 8, comprising instructions to generate a list of the determined software tests.

15. A system, comprising:
a memory;
at least one hardware processor interoperably coupled with the memory and configured to:
select particular source code of a software produce from a source code repository;
prepare the selected source code to extract information while executing;
perform a series of actions on the prepared selected source code resulting in logged data associated with the performed actions, the actions performed as part of a teaching function to learn information about software tests or scenarios for the prepared selected source code to enhance a knowledge base used to identify software tests that need to be re-run if the prepared selected source code is modified;
submit the logged data to an automatic regression analyzer application;
determine changes made to the particular source code; and
determine software tests needed to be executed to properly test the changed particular source code and other affected source code.

16. The system of claim 15, wherein preparing the selected source code includes instrumenting the selected source code.

17. The system of claim 15, wherein preparing the selected source code includes using byte code injection or aspect-oriented programming methods during building of the selected source code into executable form.

18. The system of claim 15, further configured to write the logged data to the knowledge base.

19. The system of claim 18, further configured to use rules with the knowledge base to provide analytical intelligence with respect to the written logged data.

20. The system of claim 15, further configured to monitor the particular source code in the source code repository using a watch dog agent.

21. The system of claim 15, further configured to generate a list of the determined software tests.
